(19) United States
(12) Patent Application Publication
(10) Pub. No.: US 2015/0178020 A1
(43) Pub. Date: Jun. 25, 2015

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Shinya Suzuki, Kawasaki-shi (JP)

(21) Appl. No.: 14/564,994

(22) Filed: Dec. 9, 2014

(30) Foreign Application Priority Data
Dec. 24, 2013 (JP) 2013-265793

(51) Int. Cl. G06F 3/12; H04N 1/32; H04N 1/00

(52) U.S. Cl. CPC G06F 3/1204; G06F 3/126; H04N 1/00413; H04N 1/00278; H04N 1/32064; H04N 2201/0093; H04N 2201/0082

(57) ABSTRACT

Provided is an information processing apparatus that processes and outputs print data with which print setting information is associated. The information processing apparatus executes an installer to install a printer driver and acquires destination information for use in facsimile transmission from an address book. The processing for setting a name including destination information to the generated print queue is executed. When the user designates a print queue upon printing, the processing for acquiring destination information included in the name of the designated print queue and setting the destination information to print setting information is executed to output the print setting information together with the print data to a FAX printer. A destination is set to a print queue name, so that a FAX transmission is sent to a desired destination without inputting the destination each time a FAX transmission is to be made.

### BACKGROUND OF THE INVENTION

1. Field of the Invention

The present invention relates to processing for setting destination information for use in facsimile transmission to print setting information associated with print data by using a printer driver.

2. Description of the Related Art

When a printer driver is installed in an operating system (hereinafter referred to as “OS”), the OS implements a print function by generating an object called a “print queue” and associating the object with a device. A user changes print queue settings and selects a desired print queue from an application to thereby perform printing. The name of the print queue (hereinafter referred to as “print queue name”) used is often, for example, the name of a printer driver or the model name of a printer.

A facsimile (hereinafter referred to as “FAX”) system is widely available in offices. An electronic document generated by a personal computer (PC) is printed by FAX printing using a FAX printer driver, so that the FAX transmission is performed from a device. In the system, when the user provides a FAX print instruction, the UI (user interface) is displayed in a pop-up format by a FAX printer driver and the transmission destination is set at the timing for preventing erroneous transmission. As a system for inputting information upon printing, there is a printer driver that performs UI display on a PC and then executes printing using a value input by a user operation (see Japanese Patent Laid-Open No. 2001-318779).

In the conventional technique, the transmission destination needs to be input on the UI screen displayed in a pop-up format each time the user performs FAX printing, resulting in a considerable time and labor.

### SUMMARY OF THE INVENTION

The present invention enables a FAX transmission without performing a destination setting operation each time printing is designated.

According to an aspect of the present invention, an information processing apparatus for processing and outputting print setting information and print data is provided that includes a setting unit configured to acquire destination information for use in facsimile transmission and to set a name including the destination information to a print queue which has been generated; a specifying unit configured to specify the print queue upon printing; and an output unit configured to acquire the destination information included in the name of the print queue designated by the specifying unit, set the destination information to the print setting information, and output the print setting information together with the print data.

Further features of the present invention will become apparent from the following description of exemplary embodiments with reference to the attached drawings.

### BRIEF DESCRIPTION OF THE DRAWINGS

FIG. 1 is a block diagram illustrating an example of a configuration of a computer system according to an embodiment of the present invention.

FIG. 2 is a configuration diagram of a network to which clients, a server, and printers are connected according to an embodiment of the present invention.

FIG. 3 is a block diagram illustrating a print processing system according to an embodiment of the present invention.

FIG. 4 is a diagram illustrating the relationship of correspondence between destination names and destination numbers in a table format.

FIG. 5 is a diagram illustrating an example of a print ticket in an XML format used in a driver print processing system according to an embodiment of the present invention.

FIG. 6 is a flowchart illustrating an example of destination setting processing performed by an installer according to an embodiment of the present invention.

FIG. 7 is a configuration diagram of an installer according to an embodiment of the present invention.

FIG. 8 is a diagram illustrating an example of a print queue selection screen in an application according to an embodiment of the present invention.

FIG. 9 is a flowchart illustrating an example of processing performed by a FAX printer driver according to an embodiment of the present invention.

FIG. 10 is a diagram illustrating an example of a field of a print queue object according to an embodiment of the present invention.

FIG. 11 is a flowchart illustrating an example of processing performed by a printer extension according to an embodiment of the present invention.

FIG. 12 is a diagram illustrating an example of a print queue selection screen operable to support broadcast communication in an application according to an embodiment of the present invention.

FIG. 13 is a flowchart illustrating an example of destination setting processing performed by a configuration module according to an embodiment of the present invention.

### DESCRIPTION OF THE EMBODIMENTS

Hereinafter, a description will be given of an information processing apparatus and an image forming apparatus according to embodiments of the present invention with reference to the attached drawings.

### First Embodiment

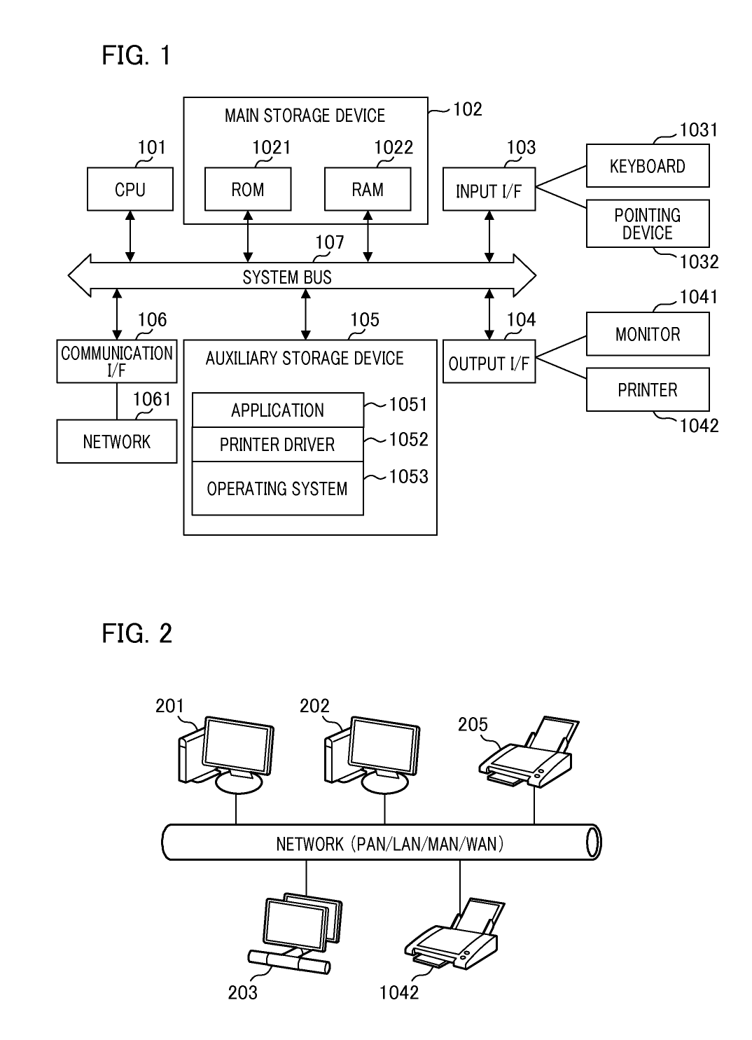

FIG. 1 is a block diagram illustrating a system with use of a typical computer according to an embodiment of the present invention.

A CPU (Central Processing Unit) 101 reads and executes a program stored in a ROM (Read Only Memory) 1021 or a RAM (Random Access Memory) 1022 of a main storage device 102 or a program stored in an auxiliary storage device 105 to control the entire apparatus. The RAM 1022 may also be used as a work area for the CPU 101 when the CPU 101 executes various types of processing. The auxiliary storage device 105 stores programs such as an application 1051, a printer driver 1052, an OS 1053, and the like. The printer driver 1052 can provide a FAX transmission instruction to a device having a FAX transmission function. An input device such as a keyboard 1031 or a pointing device 1032 represented by a mouse, a touch panel, or the like is a device which is used by a user to provide various types of instructions to a computer via an input I/F (interface) unit 103. An output I/F unit 104 is an interface unit configured to output data to an external device and outputs data to an output device such as a monitor 1041 or a printer 1042. The output I/F unit 104 is not limited to a local I/O which is directly connected to the printer 1042 but may also be connected to an external device via a network 1061 which is connected by a communication I/F unit 106. A common data system bus 107 exchanges data between I/F units or between modules.

FIG. 2 illustrates an environment of the network 1061 in a simplified manner according to the present embodiment. Client computers 201 and 202 for creating a document or an image to be printed are connected to a single network or a plurality of networks. A server computer 203 for managing a client user or a printer may also be connected to the network. The printer 1042 is connected to a single or a plurality of networks. Note that the printer 1042 may also be set in an OFF-line state not to be actually used even if physically connected as in the case of the printer 205. There are small to large networks such as a PAN, a LAN, a MAN, a WAN, and the like, where PAN is an abbreviation for “Personal Area Network”, LAN is an abbreviation for “Local Area Network”, MAN is an abbreviation for “Metropolitan Area Network”, and WAN is an abbreviation for “Wide Area Network”. The above-described devices are connected to all the networks. As in the case of a cloud system, a server or a printer may also be connected over the Internet.

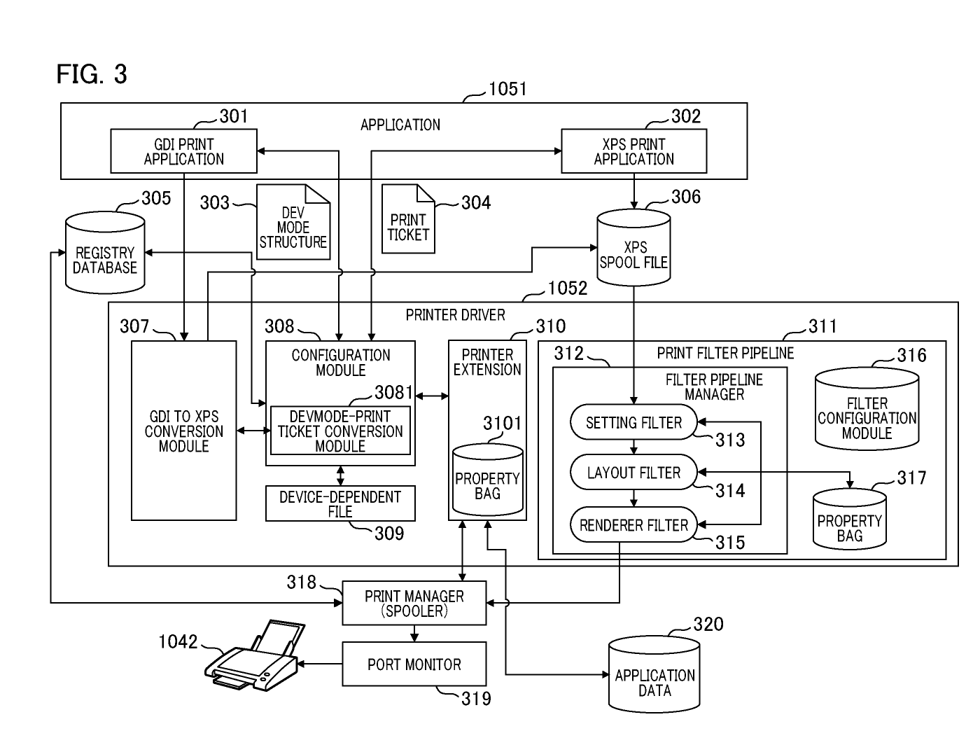

FIG. 3 is a block diagram illustrating a configuration of a driver print system. The driver print system running on the OS 1053 is a system for printing using a file format called as “XML Paper Specification” (hereinafter abbreviated as “XPS”) as spool data. A print manager 318, a GDI to XPS conversion module 307, and a filter pipeline manager 312 are modules included in the OS 1053. Although the GDI to XPS conversion module 307 and the filter pipeline manager 312 are included in the printer driver 1052, the GDI to XPS conversion module 307 and the filter pipeline manager 312 are defined as modules of the printer driver 1052 provided from the OS 1053. The filters of the printer driver 1052 and the filter pipeline manager 312 are stored as the printer driver 1052 in the auxiliary storage device 105 shown in FIG. 1. A GDI print application 301 and an XPS print application 302 are stored as the application 1051 in the auxiliary storage device 105 shown in FIG. 1. A user provides a print instruction using an input device (the keyboard 1031 or the pointing device 1032). In other words, a user can instruct execution of print processing by an operation on the UI screen of the GDI print application 301 (hereinafter referred to as “GDI application”) or the XPS print application 302 (hereinafter referred to as “XPS application”) displayed on the monitor 1041.

The print processing is executed by sequentially performing three processes, namely, selection of a printer, creation of print setting information, and conversion of rendering data. First, the selection processing for selecting the printer 1042 on which the data is to be printed is performed. When viewed from the user, selection of the printer 1042 means the same as selection of the printer driver 1052 corresponding to the printer 1042 which executes printing. A print queue is used for selecting the printer driver 1052.

Next, the processing for creating print setting information is executed. In the print setting, the application 1051 firstly secures a memory area for storing print setting on the RAM 1022. Then, the application 1051 calls a configuration module 308 of the printer driver 1052 and then creates print setting data for storage. The GDI print application 301 uses a binary DEVMODE structure 303 as print setting data. The XPS print application 302 uses a print ticket 304 described in a markup language XML. The DEVMODE structure 303 has a standard region defined by the OS and an extended region uniquely defined by the printer driver.

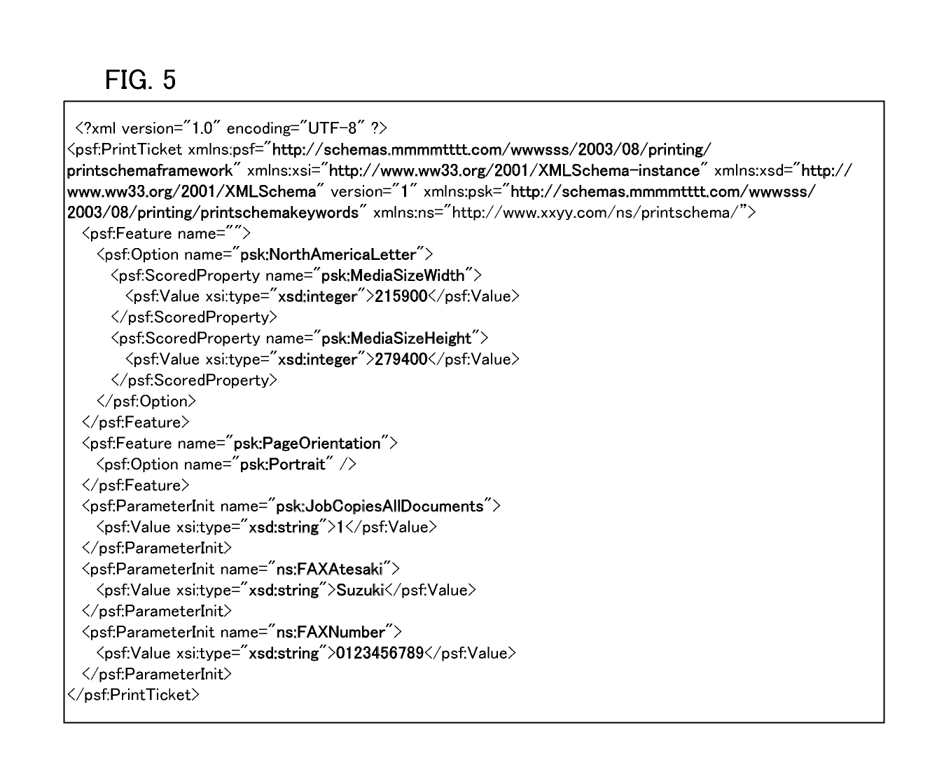

The print ticket 304 has print setting data described in XML format shown in FIG. 5, and description in the standard region and the extended region is separated by namespace. Since device-specific information is also included in print setting data, the configuration module 308 creates print setting data using a device-dependent file 309. The DEVMODE structure 303 or the print ticket 304 holds print setting data, and the application 1051 changes the print settings by directly rewriting values. Dedicated settings depending on the printer 1042 are made by using the user interface of a printer extension 310. The printer extension 310 is a type of the printer driver 1052 but is installed as another application. The printer extension 310 has a data storage area called as a “property bag 3101”. The data storage area is accessible from the printer extension 310 and the configuration module 308.

The printer driver 1052 changes the printer 1042-dependent setting data of the DEVMODE structure 303 or the print ticket 304 in accordance with the settings of the user interface. More specifically, the print setting data refers to data required for printing such as the setting of the output sheet size to “A4 size”, the change of the orientation of printing to “landscape”, transmission of a page called as a “cover sheet” on which information about an originator upon FAX transmission is printed, and the like. In the print ticket 304, the print setting data is described in XML format, and thus, the XPS print application 302 may readily rewrites all set values by directly changing them. The settings may also be changed by using the user interface of the printer extension 310. The print setting data is created each time the document print processing is performed. When data such as an environment setting for each option device of the printer 1042 or for each user is desired to be held, such data is stored in a registry database 305 of the OS via the user interface. When the registry database 305 cannot be used, setting information is stored as application data 320 via the user interface. The print manager 318 of the OS stores the default value of a print setting in the registry database 305. The registry database 305 and the application data 320 are stored in the auxiliary storage device 105.

Finally, rendering data conversion is executed. When the print settings are confirmed, the user causes the application 1051 to execute print processing. When printing is performed from the GDI print application 301, rendering data is sent to the GDI to XPS conversion module 307 which is in the form of a printer driver to create an XPS spool file 306. At this time, the GDI to XPS conversion module 307 calls the configuration module 308, and then causes the configuration module 308 to convert print setting data from the DEVMODE structure 303 to the print ticket 304. Upon conversion, a DEVMODE-print ticket conversion module 3081 is used. When printing is performed from the XPS print application 302, there are two methods: one method for generating an XPS file via the XPS application itself and the other method for generating an XPS file by the OS in response to the rendering command from the XPS application. The XPS spool file 306 is generated by either method in the course of printing.

After generation of the XPS spool file 306, the processing is passed to a print filter pipeline 311. The print filter pipeline 311 has a mechanism for performing processing by passing data through a plurality of filters and controls the number or the order of filters using a filter configuration module 316. The filter pipeline manager 312 which runs on the print filter pipeline 311 executes the processing in accordance with the filter configuration module 316. In the present embodiment, the processing is executed in the order of a setting filter 313, a layout filter 314, and a renderer filter 315. The number or the type of filters may vary depending on the configuration of the printer driver 1052. The print processing is performed by passing the XPS spool file 306 to a filter. The filter processes the XPS spool file 306 and then passes the processed XPS spool file 306 to the next filter to proceed the print processing. Finally, the output of a printer control language (Page Description Language: hereinafter abbreviated as “PDL”) which is a data language interpretable by a printer is obtained. Of course, if the printer 1042 is an XPS direct printer which can perform printing by directly reading the XPS spool file 306, the printer 1042 may perform printing without passing data through all the filters. The filters may store data in a property bag 317. Information about the OS 1053 and data of other filters may also be acquired from the property bag 317.

The setting filter 313 performs processing for reading the print ticket 304 and writing data required for printing to the print ticket 304. The layout filter 314 performs processing relating to layout such as magnification change, an imposition layout of bookbinding, and a stamp layout. The layout filter 314 operates according to the print ticket 304 included in the XPS spool file 306. Thus, when an imposition setting is not present in the print ticket 304, the layout filter 314 transmits the XPS spool file 306 to the next filter without any processing. The renderer filter 315 of final stage renders the XPS spool file 306 and converts the XPS spool file 306 into PDL data. Then, the print manager 318 for managing a schedule of print processing manages the converted PDL data, and registers print jobs in a queue (a waiting string) one after another. When the printer 1042 is ready for printing, the print manager 318 transmits the PDL data to the printer 1042 via a port monitor 319 in order of registration in the queue.

As described above, the main role of the printer driver is to convert print data from the application into PDL data to thereby perform the print processing. In the case of FAX printing, destination information is attached to the PDL data. Upon receiving PDL data and destination information, the printer 1042 performs FAX transmission using a public network.

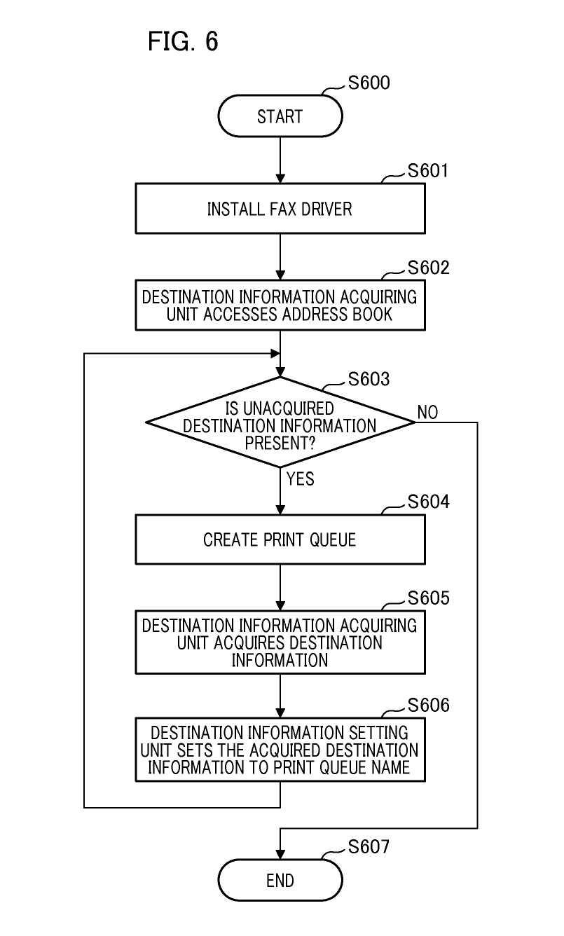

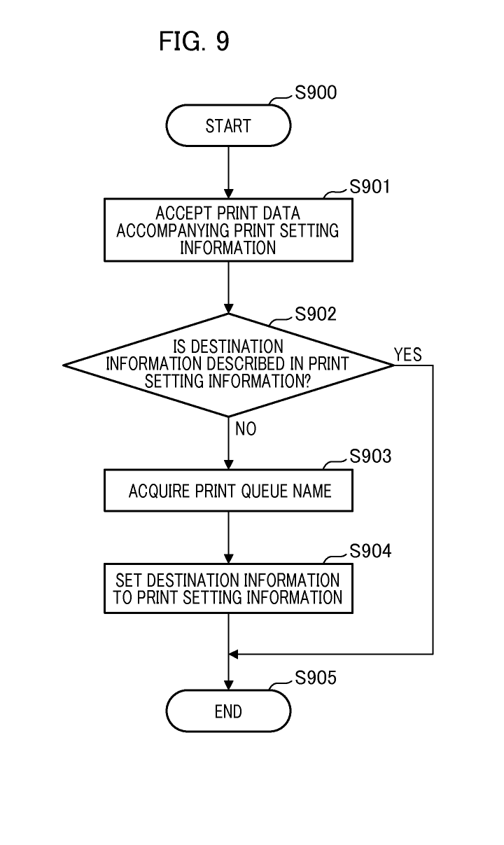

Next, a description will be given of the processing of the present embodiment with reference to the flowcharts shown in FIGS. 6 and 9.

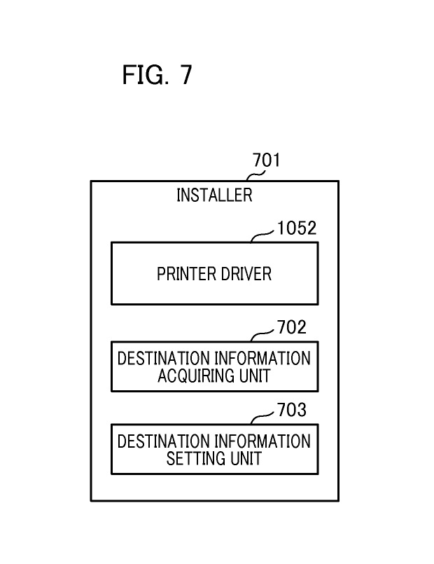

FIG. 6 is a flowchart illustrating an example of processing performed by an installation program (installer) of a FAX printer driver. The installer is executed by the CPU 101, and the printer driver 1052 is stored in the auxiliary storage device 105. FIG. 7 is a conceptual diagram illustrating a configuration of an installer 701 according to the present embodiment. The installer 701 has a printer driver 1052, a destination information acquiring unit 702, and a destination information setting unit 703. The term “destination information” refers to a set of data associated with a destination name and a FAX number. The destination information acquiring unit 702 is a program module that acquires destination information from an address book. The destination information setting unit 703 is a program module that sets destination information to a print queue name.

In step S600 shown in FIG. 6, the installer 701 starts a processing step on the OS running on the CPU 101. In step S601, the printer driver 1052 is installed. The installer 701 registers the printer driver 1052 in the OS 1053. In step S602, the destination information acquiring unit 702 accesses an address book. Here, the term “address book” refers to database for managing destination information. For example, the address book is an address book owned by the OS 1053 or an address book created by a specific application or other FAX printer driver. Furthermore, the address book may also be an address book registered in the printer 1042 or destination information management database managed by the server computer 203.

In step S603, the installer 701 determines whether or not unacquired destination information is present in the address book accessed thereby. The installer 701 has a flag indicating whether or not destination information has been acquired each time an access is made, and determines unacquired destination information with reference to the flag. The address book may also have information about the flag. If it is determined in step S603 that unacquired destination information is present, the processing proceeds to step S604. If it is determined in step S603 that unacquired destination information is not present, the processing proceeds to step S607 and the processing performed by the installer 701 ends.

In step S604, a print queue is created, and the processing proceeds to step S605. In step S605, the destination information acquiring unit 702 acquires unacquired destination information from the address book, and the processing proceeds to step S606. In step S606, the destination information setting unit 703 sets the destination information acquired in step S605 as a print queue name to the print queue created in step S604. In general, a driver name or a model name is often described as a default value of a print queue name. Thus, in the present embodiment, destination information is described by adding it to the default driver name. For example, when the driver name is a “FAX Printer 000”, setting processing is performed by adding the acquired “destination name and destination number” to the driver name. Then, the processing returns to step S603. The processing from step S603 to step S606 is repeated until no unacquired destination information remains.

In step S606, information other than destination information may also be embedded in the field of the print queue object. For example, information indicating a region set on the OS 1053 may be set to the “location” item which is one of items to be held by the print queue or a parameter indicating the type of a cover sheet or the like may be set to the “comment” item. The printer driver 1052 may determine whether or not destination information is correct or incorrect using the items or may also determine the type of a cover sheet associated therewith.

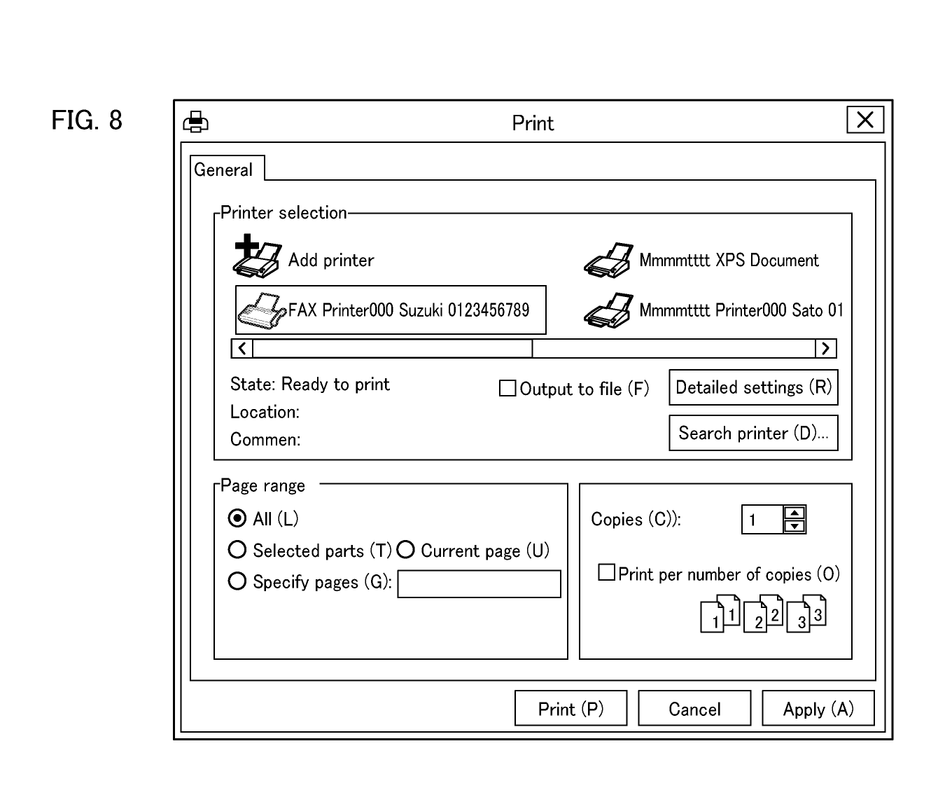

Next, a description will be given of a FAX transmission operation performed by a user with reference to FIG. 8. Upon completion of the installation processing performed by the installer 701 described with reference to FIG. 6, a print queue in which destination information is set to a print queue name is generated so as to be selectable from an application capable of printing. FIG. 8 illustrates a selection screen upon printing, and the user designates a printer by a GUI (Graphical User Interface) operation using the pointing device 1032. The user can execute FAX printing by selecting a print queue in which a desired destination is described from the application. When no destination information is set to a print queue or when destination information is incorrectly described, the print queue may be displayed in a pop-up format as in the conventional system or may be handled as an error.

FIG. 9 is a flowchart illustrating an example of destination setting processing performed by the printer driver 1052 when the user provides a FAX print instruction. In the present embodiment, a description will be given of the method for performing the destination setting processing by the setting filter 313 of the filter pipeline manager 312. Note that the processing may also be performed by other filter.

When the user designates a print queue of the destination desired to be transmitted, the printer driver 1052 receives print data accompanying print setting information from the application. The print data reaches the setting filter 313 via the print filter pipeline 311. Then, the processing performed by the setting filter 313 starts from step S900.

In step S901, the setting filter 313 accepts print data accompanying print setting information. In step S902, the setting filter 313 determines whether or not destination information is included in the print setting information. In the present embodiment, although destination information is described in a print queue name, it is also contemplated that the XPS print application 302 sets destination information to print setting information. Thus, destination information is confirmed. Of course, a setting item for prioritizing destination information for the print queue name may be set. When no destination information is described in print setting information, the processing proceeds to step S903, whereas when destination information is described in print setting information, the processing proceeds to step S905.

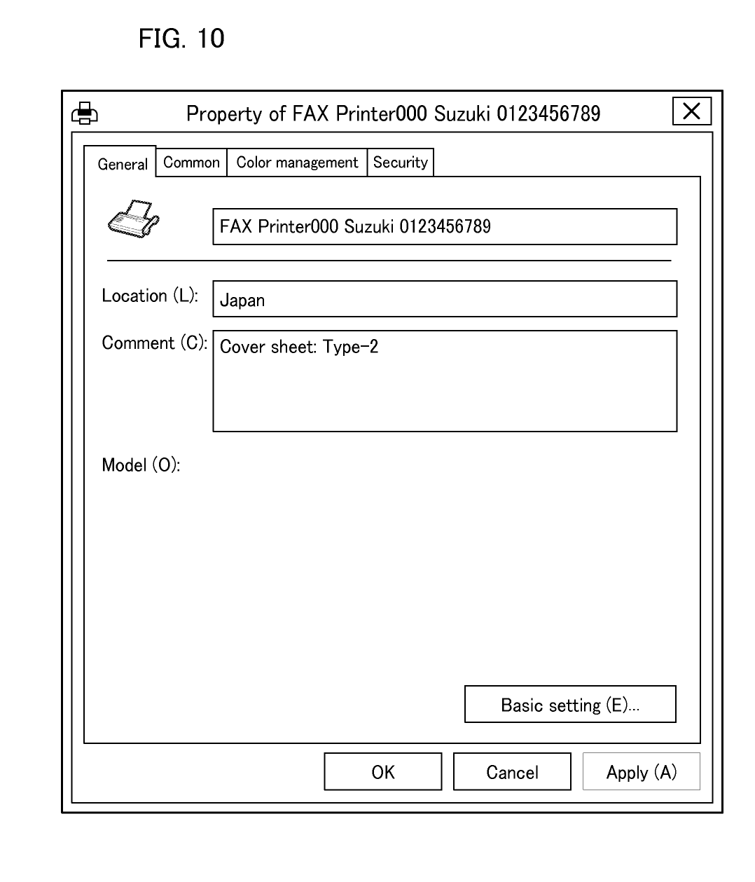

In step S903, the print queue name is acquired, and the processing proceeds to step S904. In the present embodiment, the “driver name, destination name, and destination number” are set as a print queue name, information are sequentially acquired for the respective items so as to determine whether or not the designated information is correct. For example, confirmation processing for confirming whether or not destination number is described as a correct numerical value or the like is performed. Furthermore, various settings designated in the print queue may also be used as a unit for determining a destination number. For example, when “Japan” is designated in the field of “location” of the print queue object as shown in the property screen in FIG. 10, “Japan” may be used as judgment information as to whether or not transmission can be made to the destination information described in the print queue name. When the parameter indicating the type of cover sheet is designated in the “comment” field, the cover sheet type designated by the filtering processing may also be added.

In step S904, the processing for setting destination information to print setting information is executed. For example, destination information and a destination number are described in the print ticket 304 as shown in FIG. 5. In step S905, the destination setting processing ends. When destination information is described in print setting information in step S902, the processing proceeds to step S905, and the processing ends without performing destination setting processing.

After completion of the destination setting processing, the processing for performing PDL conversion via other filters and transmitting the destination information and converted PDL to the printer 1042 is executed. The printer 1042 receives the destination information and PDL data, and then performs FAX transmission to the designated destination.

According to the present embodiment, the above processing enables a FAX transmission to be executed by acquiring destination information from a print queue name without the need for the user to perform a destination input operation each time printing is designated. Furthermore, FAX printing can be made in an environment where pop-up input is prohibited or unallowable.

The present embodiment may also be used in a point-and-print environment. The point-and-print is a function provided by Windows (registered trademark). The term “point-and-print” refers to a printer common function by which the client computer 201 can use the printer driver 1052 installed on the server computer 203 on the network. In the case of using the SSR (server side rendering) function which is the point-and-print function, the print filter pipeline 311 runs on the server computer 203. Thus, the print queue name acquired by the setting filter 313 is the print queue name of the server computer 203. Thus, even when the print queue name is changed by the client side, FAX printing is made to the destination designated by the server computer 203. Thus, since the destination can be fixed on the server computer 203 side in an environment where a FAX destination is managed at an office or the like, the administrator can readily manage FAX printing.

### Second Embodiment

Next, a description will be given of a second embodiment of the present invention. Hereinafter, the same elements as those in the first embodiment are designated by the same reference numerals and detailed explanation thereof will be omitted. The description will be given below of differences from the first embodiment.

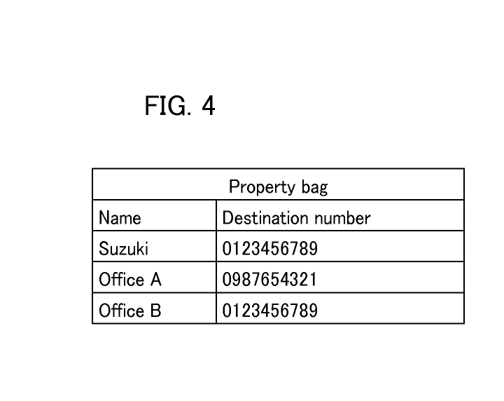

The first embodiment is not suitable for broadcast communication since a print queue and destination information are associated with each other on one by one basis. A plurality of designated destinations may also be included in the print queue name, but a too long print queue name is not readily recognizable by the user. In the present embodiment, broadcast communication can be established by using data of the property bag 3101 held by the printer extension 310 as shown in FIG. 4. The property bag 3101 shown in FIG. 4 includes destination name data and destination number data.

Here, a description will be given of the relationship between the printer driver 1052 and the printer extension 310. Since the printer extension 310 operates as another application independently of the printer driver 1052, the printer extension 310 may not be included in the printer driver. In such a case, there are two methods: one is that the users download and install the printer extension 310 by themselves and the other one is that the mechanism for automatically downloading and installing the printer extension 310 by the function of the OS 1053 is used. In the present embodiment, a description will be given of the processing to be performed after the printer extension 310 is separately installed after installation of the printer driver 1052.

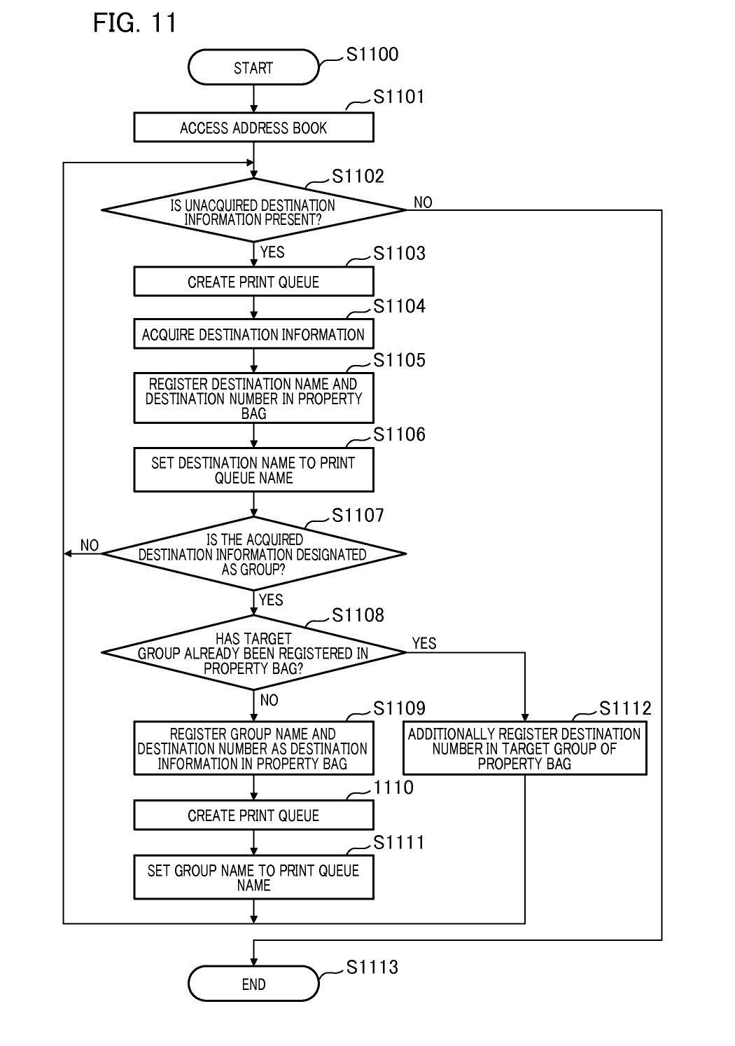

Hereinafter, a description will be given of the processing of the present embodiment with reference to the flowchart shown in FIG. 11.

First, it is assumed that the printer driver 1052 and the printer extension 310 are installed and the printer driver 1052 is associated with the printer extension 310. Then, the printer extension 310 is activated, and the processing starts from step S1100.

In step S1101, the printer extension 310 accesses an address book. The address book has already been described in the first embodiment, and thus, explanation thereof will be omitted. It should be noted that it is assumed in the present embodiment that the field called “group” (group field) is added as an item described in the address book. The term “group” refers to a group segmented by grouping destination information registered in an address book. For example, when a person A and a person B belong to a company C, these two persons can be registered in the same group. In this case, the group field of destination information about the person A and the person B can be grouped by specifying the company C.

In step S1102, the printer extension 310 determines whether or not unacquired destination information is present. When unacquired destination information is present, the processing proceeds to step S1103. When unacquired destination information is not present, the processing proceeds to step S1113. After creation of the print queue in step S1103, in step S1104, the printer extension 310 acquires unacquired destination information from the address book, and the processing proceeds to step S1105. In step S1105, the “destination name” and “FAX number” of the acquired destination information are registered as a group in the property bag 3101. In step S1106, the destination name is set to the print queue name of the print queue created in step S1103. In step S1107, it is determined whether or not the destination information acquired in step S1104 is designated as a group. Whether or not group designation has been made can be determined whether or not the group field included in destination information has been designated. When group designation has not been made, the processing returns to step S1102. When group designation has been made, the processing proceeds to step S1108.

In step S1108, it is determined whether or not the group of the acquired destination information has already been registered in the property bag 3101. When the group of the acquired destination information has not been registered, the processing proceeds to step S1109. When the group of the acquired destination information has already been registered, the processing proceeds to step S1112.

In step S1109, the processing for registering the group name and the destination number as destination information in the property bag 3101 is executed, and a print queue is created in step S1100. In step S1111, the acquired group name is set to the print queue name of the print queue created in step S1100. Then, the processing returns to step S1102.

In step S1112, the processing for additionally registering the destination number belonging to the group in the target group of the property bag 3101 is executed, and the processing returns to step S1102. When unacquired destination information is not present in step S1102, the processing proceeds to step S1113, and the processing ends.

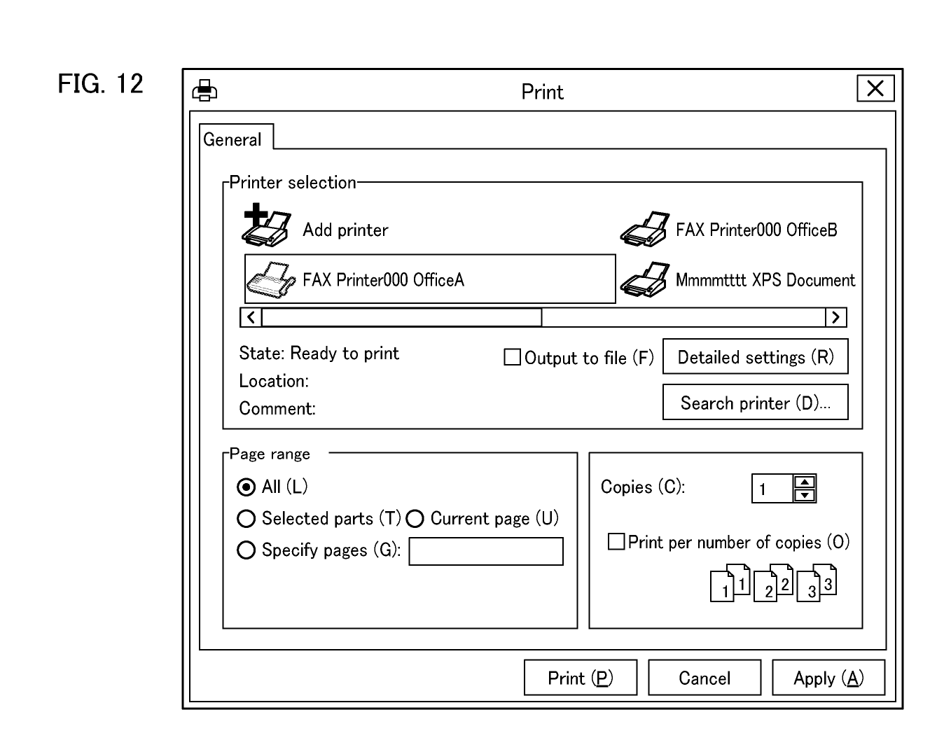

By the above processing, destination information for each individual and destination information for each group are registered in the property bag 3101, so that the print queue in which the group destination name is displayed in the print queue name is created. FIG. 12 illustrates a selection screen upon designation of a print queue. The user selects the created print queue, so that FAX transmission can be performed on a group basis. In the example shown in FIG. 12, when the user selects a print queue describing the destination to which a desired broadcast communication is established from the application, the processing performed by the printer driver 1052 starts. While the setting filter 313 sets destination information in the first embodiment, the filter configuration module 316 sets destination information in the present embodiment.

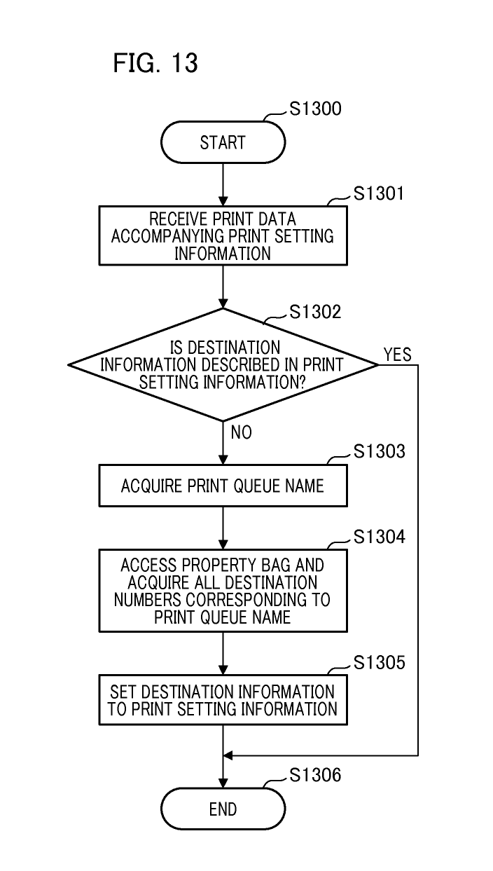

A description will be given of the processing performed by the filter configuration module 316 according to the present embodiment with reference to the flowchart shown in FIG. 13.

In step S1300, the filter configuration module 316 starts processing. In step S1301, print data accompanying print setting information is received. In step S1302, it is determined whether or not destination information is described in print setting information. When no destination information is set in print setting information, the processing proceeds to step S1303. When destination information is set in print setting information, the processing proceeds to step S1306.

In step S1303, the processing for acquiring a print queue name is executed. Next, in step S1304, the processing for accessing the property bag 3101 (FIG. 4) and acquiring all the destination numbers corresponding to the acquired print queue name is executed. At this time, the destination number may be present in plural. Then, the processing proceeds to step S1305, and all the acquired destination information is set to print setting information. The processing ends in step S1306.

When all the destination information is set in step S1302, the processing proceeds to step S1306, and the processing ends.

According to the present embodiment, the above processing enables broadcast communication. The user can execute a FAX printing without the need for the user to perform a setting operation each time a destination is input, resulting in an increase in convenience to the user.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-265793, filed on Dec. 24, 2013, which is hereby incorporated by reference herein in its entirety.

What is claimed is:

1. An information processing apparatus for processing and outputting print setting information and print data, the information processing apparatus comprising:
a setting unit configured to acquire destination information for use in facsimile transmission and to set a name including the destination information to a print queue which has been generated;
a specifying unit configured to specify the print queue upon printing; and
an output unit configured to acquire the destination information included in the name of the print queue designated by the specifying unit, set the destination information to the print setting information, and output the print setting information together with the print data.

2. The information processing apparatus according to claim 1, wherein the setting unit sets the name of a group for use in broadcast communication as destination information to the print queue.

3. The information processing apparatus according to claim 2, further comprising:
a storage unit configured to store a destination name and a destination number or the name and the destination number of the group as the destination information in a data storage area,
wherein the setting unit registers the name and the destination number of the designated group if the name of the group is not stored in the data storage area, whereas the setting unit additionally registers the destination number belonging to the designated group if the name of the group is stored in the data storage area.

4. The information processing apparatus according to claim 3, further comprising:
a display unit configured to display a print queue name including the destination name or the name of the group on a selection screen,
wherein the specifying unit performs selection processing for selecting a print queue on the selection screen.

5. The information processing apparatus according to claim 1, further comprising:
an executing unit configured to execute an installation program that performs installation of a printer driver and performs processing for acquiring the destination information from an address book and processing for setting the destination information to the name of the print queue.

6. An information processing method to be executed by an information processing apparatus for processing and outputting print setting information and print data, the method comprising:
acquiring destination information for use in facsimile transmission and setting a name including the destination information to a print queue which has been generated;
specifying the print queue upon printing; and
acquiring the destination information included in the name of the print queue designated in the specifying, setting the destination information to the print setting information, and outputting the print setting information together with the print data.

7. The information processing method according to claim 6, wherein, in the setting the name, the name of a group for use in broadcast communication is set as destination information to the print queue.

8. The information processing method according to claim 7, further comprising:
storing a destination name and a destination number or the name and the destination number of the group as the destination information in a data storage area,
wherein the name and the destination number of the designated group is registered in the setting the name, if the name of the group is not stored in the data storage area, whereas the destination number belonging to the designated group is additionally registered in the setting the name, if the name of the group is stored in the data storage area.

9. The information processing method according to claim 8, further comprising:
displaying a print queue name including the destination name or the name of the group on a selection screen,
wherein, in the specifying, selection processing for selecting a print queue is performed on the selection screen.

10. The information processing method according to claim 6, further comprising:
executing an installation program that performs installation of a printer driver and performs processing for acquiring the destination information from an address book and processing for setting the destination information to the name of the print queue.

11. A non-transitory storage medium on which is stored a program to be executed by an information processing apparatus for processing and outputting print setting information and print data,
wherein the program causes a computer provided in the information processing apparatus to execute:
setting processing for acquiring destination information for use in facsimile transmission and setting a name including the destination information to a print queue which has been generated;
specifying processing for specifying the print queue upon printing; and
output processing for acquiring the destination information included in the name of the print queue designated by the specifying processing, setting the destination information to the print setting information, and outputting the print setting information together with the print data.
